(19) United States
(12) Patent Application Publication
(10) Pub. No.: US 2006/0056319 A1
(43) Pub. Date: Mar. 16, 2006

(54) Communication system

(76) Inventors: Nikolaus Markert, Triefenstein (DE); Stephan Schultze, Lohr am Main (DE)

Correspondence Address: Striker Striker & Stenby, 103 East Neck Road, Huntington, NY, 17743, US

(21) Appl. No.: 10/529,737

(22) PCT Filed: Sep. 23, 2003
(86) PCT No.: PCT/DE03/03162

§ 371 Date: Sep. 2, 2005

(30) Foreign Application Priority Data
Oct. 2, 2002 (DE) 10246007.8

(51) Int. Cl. H04L 12/28

(52) U.S. Cl. 370/258

(57) ABSTRACT

A communication system consisting of network nodes for operating industrial machines and a method for controlling a communication system. The invention relates to a communication system consisting of network nodes (1, 2, 3, 4, 5) belonging to a control and/or drive network (11, 12) wherein control and/or regulating signals are exchanged between network nodes via a closed ring-shaped signal line (6,7) in order to operate industrial machines. A network node (2) exchanges signals with at least one other network node (1, 3) via a bi-directional signal path. At least one network node (2) comprises a switching unit (8) which can be connected to two other network nodes via two bi-directional signal paths (10). The communication system can by configured to form various networks (11,12) by means of a corresponding switching position of the switching units of the network nodes, said networks (11, 12) being provided with separate signal lines (6,7).

The invention relates to a communication system with network nodes as generically defined by the preamble to claim 1 and to a method for controlling a communication system as generically defined by the preamble to claim 10.

In the most various areas of technology, communication systems with network nodes of a control and/or drive network are used for operating industrial machines. A communication system with network nodes, in a first embodiment, connects a plurality of network nodes over a closed signal path to form a network. Data and control signals are passed through all the network nodes over the ringlike signal path. One network node is embodied for instance as a control unit. In a master/slave configuration, one control unit is provided that performs a master function and controls the other control units, which perform slave functions. For instance, a control signal is output by the master control unit via an output into the signal path and is received again via an input from the closed signal path.

To assure reliable signal information, it is for instance known, along with a primary ring as the signal path, to dispose a further signal path as a secondary ring. The secondary ring is embodied parallel to the primary ring and represents a redundant data line. If one of the two signal paths fails, then the other, intact signal path takes on the task of exchanging the data between the control units.

The object of the invention is attained by the communication system having the characteristics of claim 1 and the method for controlling a communication system as defined by the characteristics of claim 10.

One advantage of the invention is that the communication system has a plurality of networks, which can be configured flexibly. In this way, the network structure can be adapted to malfunctions of the network nodes or of the control units connected to the network nodes. The configuration can furthermore be adapted to various machine conditions as well. Depending on the particular application it may be advantageous to incorporate a network node into a first or a second network. For instance, control units that fail relatively often can be into small networks or incorporated into networks upon whose failure either a malfunction is rapidly detected or only a slight impairment of the entire communication system results. Thus the communication system as defined by claim 1 offers increased flexibility in the distribution of the various networks, which furthermore have signal paths that are independent of one another. Because of the independence of the signal paths, if one network fails, the capability of the other networks to function is advantageously unimpaired.

In a simple embodiment of a communication system, two networks can each be connected to one another via a bidirectional signal path, and the bidirectional signal path can be embodied between two network nodes of the different networks. In this way, a simple, economical connection of the two networks can be established. Depending on the embodiment, the bidirectional signal path is represented for instance by two electric lines.

Preferably, the communication system of the invention is used in printing machines, especially printing machines that have a plurality of printing units. Depending on the embodiment, the control units of one printing unit may be incorporated in a network, or the control units of all the printing units of one printing machine may be incorporated in a network.

The communication system of the invention furthermore offers the advantage that the function of the control units of the networks can be varied as a function of the distribution of the control units among the various networks. For instance, in a first configuration of the networks, one control unit can perform a master function, and in a second configuration of the networks it can perform a slave function. Correspondingly, the slave function of a control unit can be changed to a master function. Preferably, each network has one control unit with a master function.

The invention is described in further detail below in conjunction with the drawings. Shown are

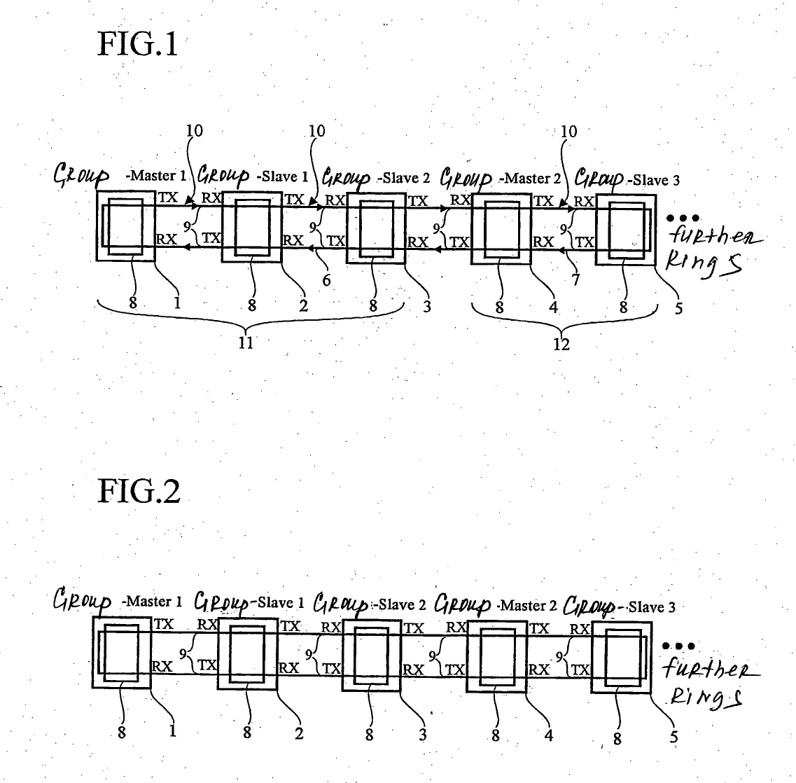

FIG. 1, a communication system with two networks;

FIG. 2, a communication system with a modified configuration of the two networks;

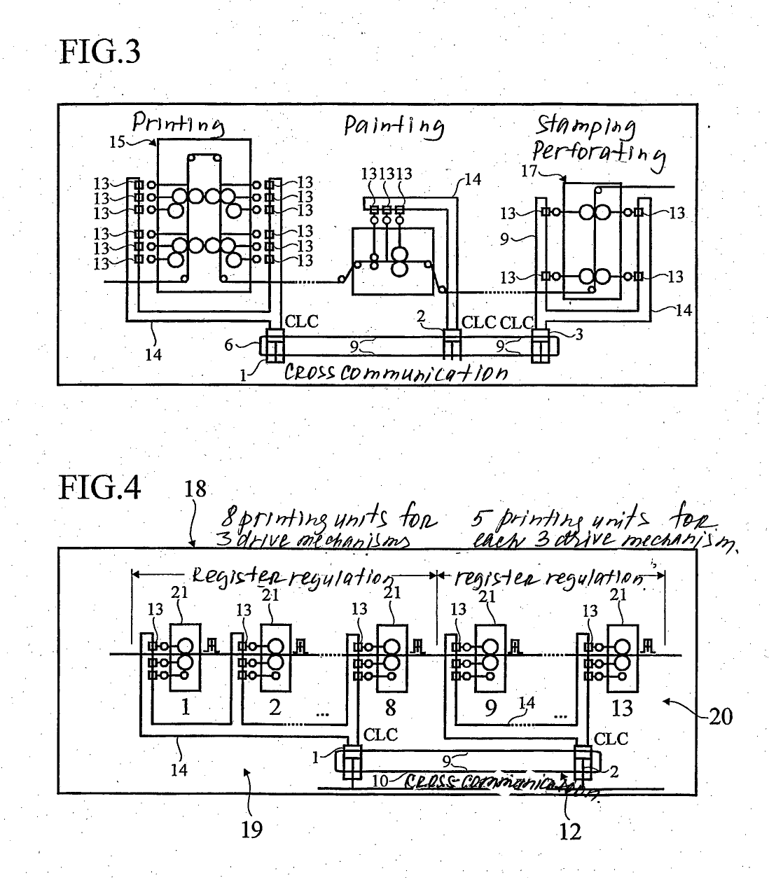

FIG. 3, a communication system for controlling a machine system;

FIG. 4, a communication system for a printing machine; and

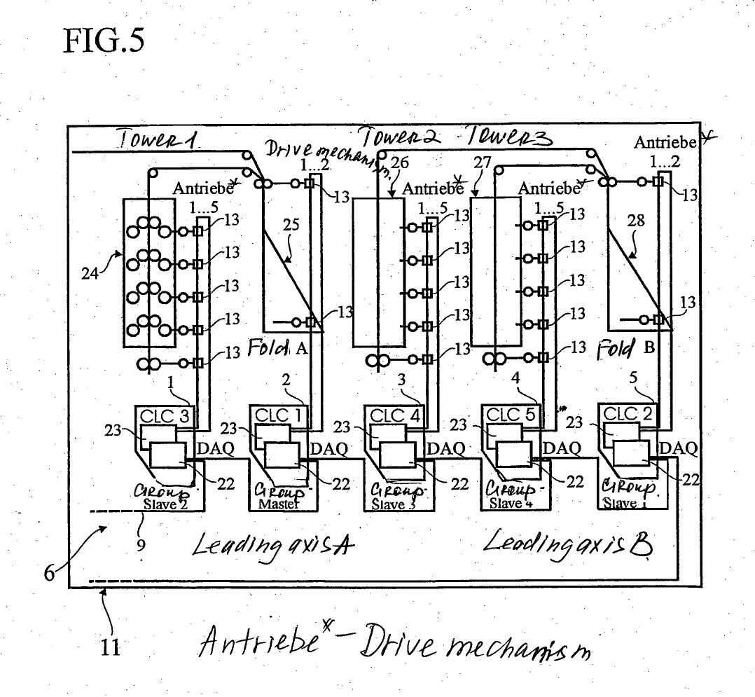

FIG. 5, part of a communication system for a rotary printing machine.

FIG. 1 shows a communication system with network nodes 1, 2, 3, 4, 5. The communication system is divided up into two networks 11, 12. The first network 11 includes the first, second and third network nodes 1, 2, 3. The second network 12 includes the fourth and fifth network nodes 4, 5. Each network node has one switchover unit 8.

The master control unit bindingly specifies control commands and a time-slot pattern for the slave control units.

The second network 12 has the fourth and fifth network nodes 4, 5. The fourth and fifth network nodes are connected to one another via two lines 9. The two lines 9 represent a bidirectional signal path 10. The bidirectional signal path 10 has one signal course for each transmission direction. For each signal course, one line 9 is used.

The lines 9 of the first and second networks 11, 12 each communicate with switchover units 8 of the network nodes 1, 2, 3, 4, 5. A switchover unit 8 of a network node 1, 2, 3, 4, 5 has the functionality that, as a function of the switching position of the switchover unit 8, the switchover unit 8 connects the lines 9 of a network node 1 through 5 with one another, and these lines carry signals in one direction through the network node 1, 2, 3, 4, 5. In FIG. 1, the line 9, which delivers signals from the first network node 1 to the second network node 2 at the input RX, communicates via the switchover unit 8 of the second network node 2 with the line 9 that carries signals from the second network node 2 to the third network node 3 via the output TX. Correspondingly, the switchover unit 8 of the second network node 3 connects the line 9, which delivers signals from the third network node 3 to the second network node 2, to the line 9, which carries signals from the second network node 2 to the first network node 1.

In a second switching position, the switchover unit 8 interrupts the communication of the lines 9 that carry the signals in one direction through the network node 1, 2, 3, 4, 5 and connects the lines 9 of a signal path 10, by way of which lines signals are exchanged between two network nodes, to one another.

Depending on the application, preferably at least the master control unit is connected to a data bus, by way of which configuration commands from outside for configuring the networks 11, 12 are delivered. Since the switching position of the switchover unit 8 is variably adjustable, the configuration of the communication system can be adjusted flexibly. This offers the advantage that defects in one line 9, for instance, of a network 11, 12 are excluded. For instance, one of the lines 9, which is embodied between the third and fourth network nodes 3, 4, could be defective. This defect has an influence on the capability of the first and second networks 11, 12 to function, since the first and second networks 11, 12 do not communicate with one another over the two lines 9 that are embodied between the third and fourth network nodes 3, 4. The first and second networks 11, 12 each have their own ringlike, closed signal course. In the second network 12, the control unit of the fourth network node 4 forms the master control unit, and the control unit of the fifth network node 5 forms the slave control unit.

A further advantage of the flexible embodiment of the differing size of the networks 11, 12 is that the network nodes 1 through 5 can be connected to one another in a different distribution to make various networks.

In a simple embodiment, all five network nodes 1, 2, 3, 4, 5 could form a single network. All that is required for this is to switch over the switchover unit 8 of the third and fourth network nodes 3, 4 accordingly. The number of networks and network nodes is not limited to the numbers in the exemplary embodiment but instead can be selected to suit the particular application.

In the embodiment shown in FIG. 3, the control unit of the first network node 1 takes on the master functionality, which specifies a leading axis for the second and third network nodes 2, 3. The first, second and third network nodes are realized by a first, second and third control unit, respectively.

The control unit of the first network node 1 takes on the control of the drive mechanisms 13 that are provided for controlling a printing unit 15 of a printing machine. The control unit of the second network node 2 controls the drive mechanisms 13, connected to the second network node 2, that are associated with a painting unit 16. The control unit of the third network node 3 controls the drive mechanisms 13 that are associated with a stamping unit 17.

The flexible configuration of the communication system of the invention offers the advantage that depending on the makeup of a processing complex and its subsidiary units, networks of different sizes can be formed. For instance, functions that are of lesser importance for the mode of operation of the processing complex may be controlled in a dedicated network. Functions that are especially critical for a correct mode of operation of the processing complex are likewise handled in a dedicated network. There is furthermore the possibility, for instance in the embodiment of FIG. 3, if the stamping unit 17 fails, to interrupt the signal path 10 between the second and third network nodes, yet printing and painting of a printed item is still possible. Hence failure of the stamping unit 17 does not cause a complete failure of the processing complex of the communication system. A failure of the stamping 17 is recognized for instance by the master control unit of the first network node 1, which performs a corresponding monitoring of the slave control units of the second and third network nodes 2, 3.

The first and second networks 11, 12 each have one master control unit. If the master control unit of the first or of the second network 11, 12 fails, for instance, and the other control units of the network 11, 12 are incapable of taking on the master function, then an interconnection of the first and second networks 11, 12 may be effected. The master control unit that is still functioning then takes on the master function for the first and second networks 11, 12. Thus in this application as well, the embodiment of a communication system with a plurality of networks which can be configured flexibly has substantial advantages.

FIG. 5 shows a different embodiment of the communication system of the invention. In FIG. 5, part of a rotary printing machine with two folding machines is shown schematically. FIG. 5 shows part of a first ring line 6, which is connected to five network nodes 1, 2, 3, 4, 5. The first ring line 6 has two parallel lines 9. In this exemplary embodiment, a network node 1 through 5 has an interface 22 and a control unit 23. The interface 22 serves the purpose of data exchange between the ring line 6, which has two lines 9, and the control unit 23. The control unit 23 serves to control drive mechanisms 13. The control unit 23 is connected to the interface 22 via a data connection. In the exemplary embodiment shown, the interface 22 simultaneously takes on the function of the switchover unit 8. The interface 22 is controlled by the control unit 23. The functionality of the switchover unit 8 is preferably implemented via software programs. The control unit 23 is connected to drive mechanisms 13 of a first printing tower 24. The control unit 23 of the second network node 2 is connected to drive mechanisms 13 of a folding machine. The control unit 23 of the third network node 3 is connected to drive mechanisms 13 of a second printing tower 26.

The further ring lines 14 for instance represent a Synax control group produced by Indramat. The drive mechanisms 13 preferably have an electronic gear functionality, which enables shaftless synchronization of the drive mechanisms 13. Each control unit of a network node preferably calculates its own leading axis, which is defined as a function of the leading axis of the master control unit, and which is followed by the drive mechanisms 13 that are triggered by the control unit. The use of a master control unit offers the advantage that the master control unit can be embodied in an especially fail-safe way and is for instance securely supplied with voltage. A failure of the master functionality is thus avoided. Hence a shutoff of the communication system and hence of the triggered machine is assured without damaging the machine, even if there is a defect in one of the further control units. The first and second ring lines 6, 7 preferably represent a closed optical waveguide ring.

Because of the flexible distribution of the networks, a control unit that is defective or must be switched off can for instance be removed from the other networks. Thus the other networks continue to be functional even though one control unit has been switched off. Hence shutting off one control unit does not impair the capability of the other control units to function.

1. A communication system having network nodes (1, 2, 3, 4, 5) of a control and/or drive network (11, 12), wherein for operating industrial machines, in particular printing machines, control and/or regulating signals are exchanged between the network nodes via a closed ringlike signal line (6, 7),
in which one network node (2) exchanges signals with at least one further network node (1, 3) over a bidirectional signal path (10),
in which at least one network node (2) has a switchover unit (8),
in which the switchover unit (8) can be communicate with two further network nodes (1, 3) via two bidirectional signal paths (10),
in which the switchover unit (8) in a first switching position connects the two signal paths (10) in the manner of a bidirectional conduction of the signals through the network node (2),
in which the switching unit (8) in a second switching position interrupts the communication between the two signal paths and connects two signal courses (9) of at least one bidirectional signal path (10) to one another,
characterized in that
the communication system can be configured into various networks (11, 12) via a suitable connection of the switchover units (8) of the network nodes (1, 2, 3, 4, 5); and
that the networks (11, 12) have separate signal lines (6, 7) from one another.

2. The communication system as recited in claim 1, characterized in that two network nodes (3, 4) of two networks (11, 12) are each mechanically connected to one another via two lines (9) which are embodied between the two network nodes (3, 4).

3. The communication system as recited in claim 1, characterized in that a network node (1, 2, 3, 4, 5) is connected to a control unit (23).

4. The communication system as recited in claim 1, characterized in that each network (11, 12) has one control unit with a master function and at least one control unit with a slave function.

5. The communication system as recited in claim 1, characterized in that the switchover unit (8) is switchable via a software controller.

6. The communication system as recited in claim 1, characterized in that one network (11, 12) is configured in accordance with a leading axis and the dependent following axes of a controller of a machine system; and that all the control units which execute control tasks as a function of the leading axis and all the control units that execute control tasks as a function of following axes of the leading axis are combined into one network (11, 12).

7. The communication system as recited in claim 6, characterized in that the machine system represents a printing machine (18) with a plurality of printing units (21).

8. The communication system as recited in claim 7, characterized in that a control unit (1) is connected to a further ring line (14);
that the further ring line (14) is connected to drive mechanisms (13) of a printing unit (21); and
that the control unit (1) controls the drive mechanisms (13) chronologically synchronously.

9. The communication system as recited in claim 7, characterized in that control units (1, 2, 3) of a plurality of printing machines (18, 20) are connected to one network (11, 12) and are supplied by the network with control signals;
that a control unit performs a master function for the further control units, which perform slave functions.

10. A method for controlling a communication system as recited in claim 1,
characterized in that
a change in the configuration of the networks (11, 12) is performed by means of software commands.

11. The method as recited in claim 10, characterized in that if a malfunction occurs upon data exchange, a change in the configuration of the network is performed in order to exclude defective signal communication and/or a defective network node or a control unit from one network (11, 12).

12. The method as recited in claim 11, characterized in that the configuration of the network is performed as a function of a configuration of a plurality of machines of a processing group, in particular a printing machine (18).

13. The method as recited in claim 12, characterized in that if a malfunction occurs in a machine of the production group, the network node which supplies the defective machine with control signals is excluded from the network (11, 12).
